(19) United States
(12) Patent Application Publication
(10) Pub. No.: US 2009/0288891 A1
(43) Pub. Date: Nov. 26, 2009

(54) APPARATUS, SYSTEM, AND METHOD FOR EXPANDABLE PHOTOVOLTAIC PANEL ELECTRICITY GENERATION

(76) Inventor: Paul Budge, St. George, UT (US)

Correspondence Address: Kunzler & McKenzie, 8 EAST BROADWAY, SUITE 600, SALT LAKE CITY, UT, 84111, US

(21) Appl. No.: 12/469,587

(22) Filed: May 20, 2009

Related U.S. Application Data
(60) Provisional application No. 61/054,655, filed on May 20, 2008.

(51) Int. Cl. B60K 16/00

(52) U.S. Cl. 180/2.2

(57) ABSTRACT

An apparatus, system, and method are disclosed for expandable photovoltaic electricity generation for a motorized vehicle. The present invention includes one or more retractable photovoltaic panels configured to increase solar energy collection when deployed. The invention further comprises a storage module configured to hold the photovoltaic panels when not in use. The storage module is portable with the motorized vehicle.

### CROSS-REFERENCES TO RELATED APPLICATIONS

This application claims the benefit of U.S. Provisional Patent Application No. 61/054,655 entitled “APPARATUS, SYSTEM, AND METHOD FOR EXPANDABLE PHOTOVOTAIC PANEL SYSTEM” and filed on May 20, 2008 for Paul Budge which is incorporated herein by reference.

### BACKGROUND

1. Field

This invention relates to solar panels and more particularly to photovoltaic panels for motor vehicles and other transportation vehicles.

2. Description of the Related Art

As electric vehicles become more and more prevalent and concern for environmental pollution is brought to the fore there is increasing interest in the generation of clean electric energy. Currently, many electric vehicles have batteries or the like which allow the storage of electric energy. These batteries are generally re-charged by plugging the vehicle into an outlet at a home or workplace. Although such an electric vehicle may not use gasoline, the electric energy from an outlet was generated somewhere and usually resulted in some form of pollution to the environment.

One promising area of technology is the generation of electric energy by photovoltaic (PV) cells. PV cells generate electricity directly from the sun and thus do not produce any harmful chemicals into the atmosphere. PV cells are especially desirable for electric vehicles because they are much more compact and portable than other methods of generating electric energy.

PV cells are generally built into PV panels which are exposed to the sun to generate electricity. On electric vehicles, PV panels are often fixed on a surface of the vehicle or are sometimes even used to replace the body paneling of a vehicle. This allows the panels to be transported with the vehicle and gives the vehicle the ability to generate electricity anywhere it goes. This provides additional flexibility in traveling with the vehicle because electric outlets are often not available.

However, there are significant shortcomings for attaching PV panels to the surface of a vehicle or using the PV panels for body paneling of the vehicle. First, because of the size and geometry of vehicles, the amount of surface area exposed to the sun (effective surface area) is generally small. It thus takes a long time to generate and store enough electricity for the operation of the vehicle. In the past, it has been attempted to remedy this shortcoming by significantly altering the shape of the vehicle. But such shapes often lead to an unusable or very inconvenient vehicle. Further, safety standards are often more difficult to meet when structural vehicle parts are replaced by or covered in photovoltaic panel material.

A second shortcoming is the constant exposure of the panels to potentially damaging events. Rocks, dust, water, and mud are just a few things that are encountered by vehicles on almost a daily basis and which may dirty or damage PV panels. Having the panels built onto or integrated into the surface of a vehicle exposes them to these events, even when no electricity is needed or being generated. This results in large costs for replacing and maintaining these vehicles and these costs rarely outweigh the benefits of the PV panels to the general consumer.

Finally, the PV paneling often ugly or undesirable in appearance. This is partly because the paneling itself is generally not very attractive but also that the altered shapes of the vehicles are unattractive. Because consumers generally look for eye-pleasing vehicles, this is a big challenge for electric vehicles.

These shortcomings are probably some of the reasons that electric vehicles are having difficulties gaining prevalence or that PV panels are rarely used on commercially produced electric vehicles.

### SUMMARY

From the foregoing discussion, it should be apparent that a need exists for an apparatus, system, and method for PV paneling to be used for generating energy for an electric vehicle which overcomes the mentioned shortcomings. Beneficially, such an apparatus, system, or method would allow an electric vehicle to have a larger effective surface area of PV panels without requiring the geometry of the vehicle to change, would minimize the costs of repair and maintenance of the panels, and would allow the vehicles to be pleasing to the eye.

The present invention has been developed in response to the present state of the art, and in particular, in response to the problems and needs in the art that have not yet been fully solved by currently available PV vehicle paneling systems. Accordingly, the present invention has been developed to provide an apparatus, system, and method for expandable photovoltaic panel electricity generation which overcomes many or all of the above-discussed shortcomings in the art. Further, the present invention is applicable to a wider range of situations the prior PV vehicle panels because of its ability to conveniently and portably generate electricity.

The apparatus to generate electricity for a motorized vehicle is provided with a plurality of retractable PV panels and a storage module which can hold the PV panels when not in use. According to one exemplary embodiment, the PV panels are flexible and are connected end to end and can be rolled up for storage inside a canister. The canister may be stored in various locations on the vehicle. According to one exemplary embodiment, the canister is stored in the rear bumper. The PV panels can then be unrolled and extended to the front end of the vehicle and attached to the front bumper when the vehicle battery needs to be charged. According to one exemplary embodiment, the PV panels may be flexible in one direction, but not the other, allowing the panels to bow above the surface of the vehicle.

According to another exemplary embodiment, the PV panels are rigid and are stored in the storage module when not in use. The rigid panels are stacked when not in use and then are extended in various directions when deployed. According to one exemplary embodiment, the storage module is located on a surface of the vehicle, such as the vehicle, hood, roof, or trunk. According to another exemplary embodiment, the storage module is located beneath the surface of the vehicle, such as under the hood, roof, or trunk panel. When deployed, the PV panels may be extended in various directions to cover the car and begin electricity generation.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a perspective drawing of the side view of a vehicle with one exemplary embodiment of an expandable photovoltaic panel system.

FIG. 2 is a drawing of the front view of a vehicle with one exemplary embodiment of an expandable photovoltaic panel system.

FIG. 3a is a drawing of the side view of a vehicle with one exemplary embodiment of an expandable photovoltaic panel system.

FIG. 3b is a drawing of the side view of a vehicle with one exemplary embodiment of an expandable photovoltaic panel system.

FIG. 4 is a drawing of the side view of a vehicle with one exemplary embodiment of an expandable photovoltaic panel system.

FIG. 5a is a drawing of the side view of a vehicle with one exemplary embodiment of an expandable photovoltaic panel system.

FIG. 5b is a drawing of the top view of a vehicle with one exemplary embodiment of an expandable photovoltaic panel system.

FIG. 6 is a schematic flow chart diagram illustrating one embodiment of an expandable photovoltaic panel system.

FIG. 7 is a schematic flow chart diagram illustrating one embodiment of an expandable photovoltaic panel system.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Photovoltaic (PV) cells operate by absorbing solar energy and inducing a flow of electric current. Thus, panels that are not contacted by sufficiently direct sunlight will not produce electric energy. As mentioned previously, due to the shape of conventional vehicles, much of the surface of a vehicle is not exposed to the sun's rays at a given instant in time. Thus, PV panels that conform to the shape of a vehicle will only partially be exposed to sunlight. PV surfaces that are sufficiently exposed to the sun's rays to produce an electric current will be referred to as “effective surface area.”

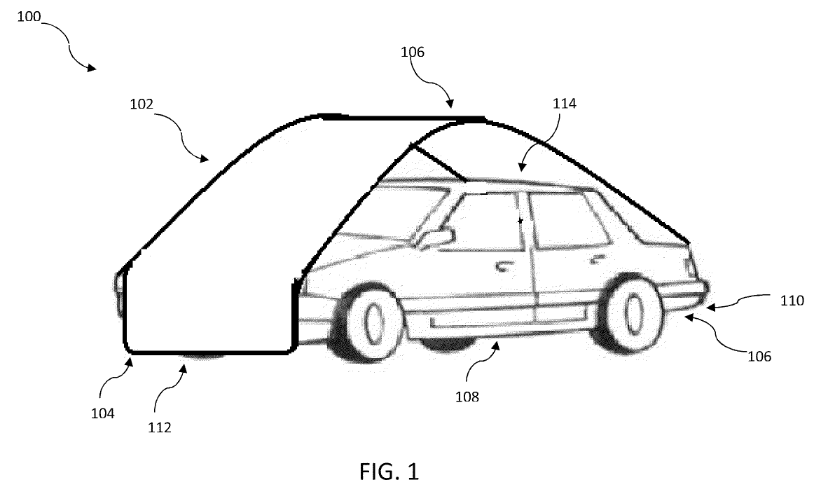

FIG. 1 is a drawing of one illustrative embodiment of an extendable photovoltaic panel system 100 as disclosed herein. A vehicle 114 is shown with a PV panel covering 106 extended over it. The effective surface area 102 is much larger than the surface area of the vehicle 114 that is available for conventional PV paneling.

Under the embodiment of FIG. 1, the photovoltaic panel covering 106 is extended from the rear of the vehicle 110 to the front of the vehicle 112. The photovoltaic panel covering 106 is not attached to the vehicle except for the points of contact at the front 112 and rear 110 of the vehicle. The photovoltaic panel covering 106 is self supporting through the use of flexing photovoltaic panels with a semi-stiff backing. The backing allows the photovoltaic panel covering 106 to roll tightly in one direction but only to flex slightly in the opposing direction.

In this way the photovoltaic panel covering 106 bows outward from the vehicle and is able to hold itself above the surface of the vehicle. This configuration also allows the photovoltaic panel covering 106 to roll tightly for storage. The photovoltaic panel covering 106 is stored or only partially deployed while the vehicle is in motion. The large sheet covering gives a much larger effective surface area 102 than is available from the top surface of the vehicle 114. The effective surface area 102 can reach sizes up to one-hundred and fifty square feet and be up to ten times the size of the effective surface area available from the vehicle surface alone.

The vehicles that can be covered by the expandable photovoltaic panel system include any size of car, truck, bus, boat, snowmobile, four-wheeler, bicycle, utility trailer, camping trailer, or any other trailer or transportation module.

The photovoltaic panel covering 106 can be deployed automatically in a manner similar to the cover of a convertible vehicle. Mechanical arms extend the photovoltaic panel covering 106 from the rear of the vehicle 110 to the front of the vehicle 112. A truss system keeps the photovoltaic panel covering 106 from resting on the car, similar to the truss system used to hold the covering of a convertible vehicle. In another embodiment, a track is placed on the top surface of the vehicle 114 and the photovoltaic panel covering 106 moves along the track until the vehicle is covered.

Under the embodiment of FIG. 1, the photovoltaic panel system comprises a PV panel covering 106 for a vehicle. In one exemplary embodiment, the photovoltaic panels are placed on a semi-rigid backing to support them over the surface of the vehicle. The system is expandable in the sense that the covering can be stored and deployed. When the photovoltaic covering is deployed, it covers a large surface area that consists of mostly effective surface area 102. The effective surface area 102 that is available with the photovoltaic panel system is larger than the surface area available from covering the entire body of the vehicle and is much more convenient to implement.

The photovoltaic panel covering 106 is stored by rolling the sheet toward the rear of the vehicle 114. In another embodiment, the photovoltaic panel covering 106 is stored under the vehicle body 108 without rolling. In another embodiment, the photovoltaic panel covering 106 is rolled tightly and stored in a canister placed on the exterior of the vehicle. In another embodiment, the sheet is stored in a box that is attached to the tow hitch on the rear of the vehicle 110. This makes the photovoltaic panel system easy to remove and allows the user to attach the box only when the photovoltaic panel covering 106 will be useful. It can be attached for times when the vehicle will be sitting in the sun and removed for the winter months or when sunlight is scarce and there is a high chance of precipitation.

Under one embodiment, the extendable photovoltaic panel system 100 is added to the vehicle as an aftermarket piece of equipment. Under another embodiment, the photovoltaic panel system is manufactured as an integral part of the vehicle. In both embodiments, the extendable photovoltaic panel system is much less expensive to employ than a system in which photovoltaic panels are manufactured as part of the vehicle body.

Under one embodiment, the extendable photovoltaic panel system 100 can be moved from one vehicle to a different vehicle when it is added as an aftermarket piece of equipment. Individualized expandable photovoltaic panel systems can be made to conform to the size and space available on the vehicle.

In one embodiment, the energy derived from the expandable photovoltaic panel system 100 is used to power part of a vehicle engine. In one embodiment, the energy derived from the expandable photovoltaic panel system 100 is used to power a climate control system inside the vehicle. This will keep the inside of the vehicle at a controlled climate without the need to run the vehicle engine. In another embodiment, the energy derived from the expandable photovoltaic panel system 100 is used to power devices external to the vehicle such as construction site equipment and camping equipment.

In one embodiment, the expandable photovoltaic panel system 100 is used to power an electrical engine. In one embodiment, the expandable photovoltaic panel system 100 is used to power an electrical motor. In one embodiment, the expandable photovoltaic panel system 100 is used to power an appliance. The photovoltaic panel system can be used to charge any energy storage apparatus. Under one exemplary embodiment, the energy storage apparatus is a battery. Under one embodiment, the expandable photovoltaic panel system 100 is used to power a fuel process. Under one embodiment, the fuel process consists of energy storage through the use of hydrogen gas.

Under one alternative exemplary embodiment, not shown, an expandable photovoltaic panel system extends over the vehicle from one lateral side of the vehicle to the other lateral side of the vehicle.

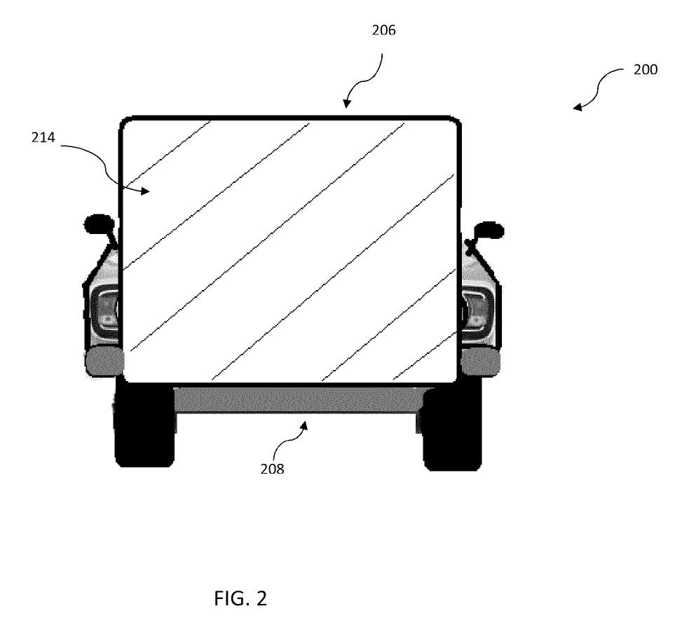

FIG. 2 shows a front view of the embodiment of FIG. 1. The increased effective surface area is easily seen in this view.

The decrease in cost associated with photovoltaic panel system 100 shown in FIG. 1 will be augmented as the technology for thin film photovoltaic panels improves. Photovoltaic panels are now being created that are thinner, lighter, and that have a higher collection ratio than past options.

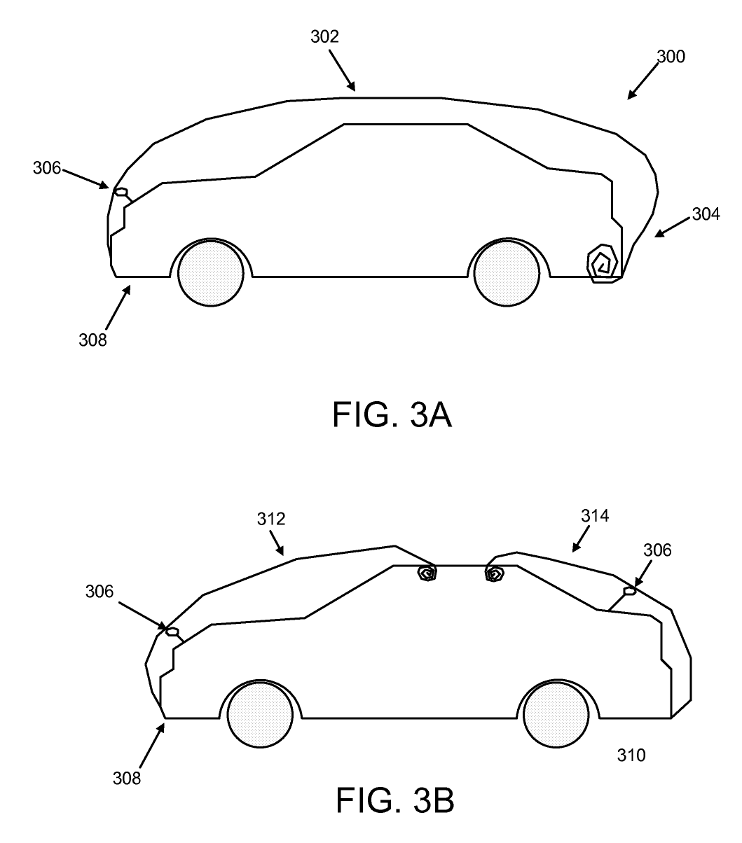

FIG. 3 depicts the storage of the photovoltaic panel covering 106 in one exemplary embodiment. Under the embodiment of FIG. 3, the photovoltaic panel covering 302 is stored by rolling in the underside of the rear of the vehicle 304. A rolling attachment 306 is placed near the front of the vehicle 308 to hold the photovoltaic panel covering 302 off of the body of the vehicle. Additional rolling attachments may be placed along the upper portion of the vehicle as well. The rolling apparatus can be a ball bearing apparatus, a wheel apparatus, a set of wheel apparatuses, a low friction material, or any other apparatus over which the panels could be deployed which would not damage the panels and which would allow them to move past the apparatus.

This embodiment can be deployed automatically or manually. The retraction mechanism may be a winder with an electrical motor, a manual winder, a spring loaded winding mechanism, a system of clamps and motors to fold or stack the panels or any system designed to assist in the storage of the panels. Each of these embodiments also allows for the photovoltaic paneling to be deployed in several directions to cover the surface area of the vehicle. Under one embodiment, the panels extend toward the front and rear of the vehicle from the center portion of the vehicle. See FIG. 3b. Under another embodiment, the panels extend from the front of the vehicle to the rear of the vehicle. Under another embodiment, the panels extend from the rear of the vehicle to the front of the vehicle. Under one embodiment, the panels extend from the center of the vehicle toward the front, rear and sides of the vehicle.

Under one embodiment, the expandable photovoltaic panel system will be stored when it is not in use. The system will store compactly in a specified location in the vehicle. This allows the user to deploy the system when the car is parked, store the system and then travel in the vehicle as if the system was not part of the vehicle. There are several storage methods for the photovoltaic paneling. In one embodiment, the photovoltaic paneling is stored under the vehicle body 108, FIG. 1 in sheet form. In this embodiment, the photovoltaic paneling is designed to be stored flat underneath the vehicle.

In another exemplary embodiment, multiple layers are stored under the vehicle by stacking the flat photovoltaic paneling. In another embodiment, the photovoltaic paneling is rolled together on the underside of the rear of the vehicle 304. In one embodiment, the rolled photovoltaic panels are stored in a canister. In another embodiment, the rolled photovoltaic panels are stored in a box that is attached to the rear portion of the vehicle. In another embodiment, the rolled photovoltaic panels are stored in the trunk space of the vehicle.

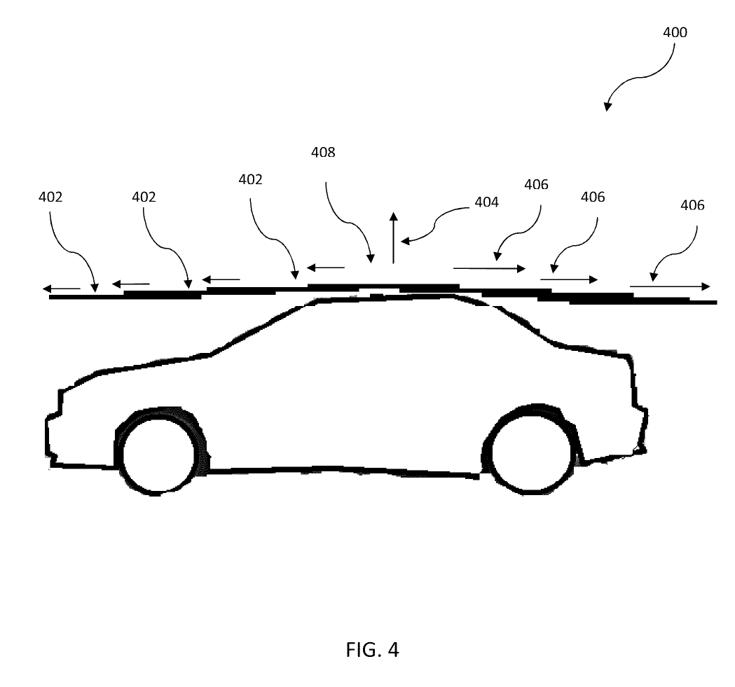

Under the embodiment of FIG. 4, the photovoltaic panels are stacked and stored on the roof of the vehicle. In this embodiment, the panels store similarly to a sliding sun roof piece. In another embodiment, the photovoltaic panels are stored in the front and rear bumpers of the vehicle. This allows the system to be completely undetectable when fully stored.

The photovoltaic panels may also be stored directly on top of the surface paneling of the vehicle. In one embodiment, the expandable photovoltaic panel system is stored by stacking the photovoltaic paneling on top of the body paneling of the vehicle. In one embodiment, the photovoltaic panels are stacked on the trunk lid of the vehicle so that they are less noticeable and do not obstruct the view of the driver.

The photovoltaic panels may also be stored under the body paneling of the vehicle. This is accomplished by leaving extra space under the body paneling of the vehicle to allow the photovoltaic panels to slide under the body paneling. In one embodiment, the vehicle roof, hood, and truck lid are designed to allow the photovoltaic paneling to slide under the body paneling of these areas of the vehicle. In one embodiment, the area under the body paneling is large enough to allow the paneling to fold or stack when stored. In each of these embodiments, sufficient space is allowed for retraction mechanisms.

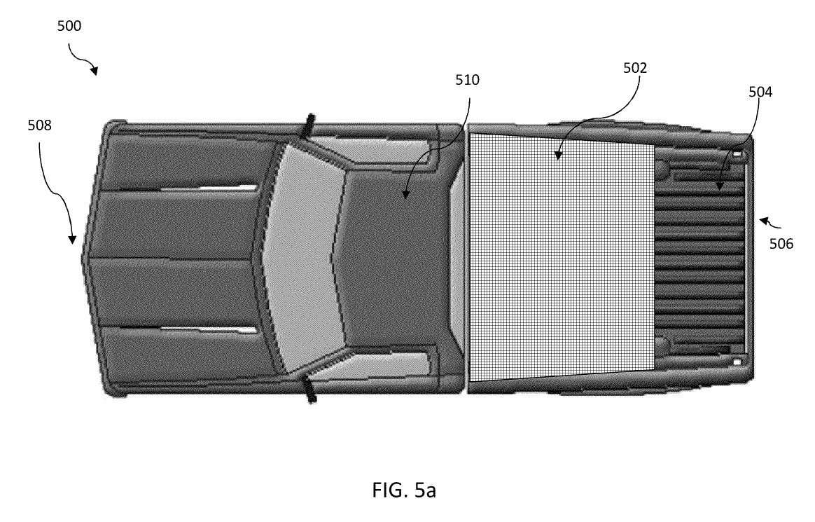

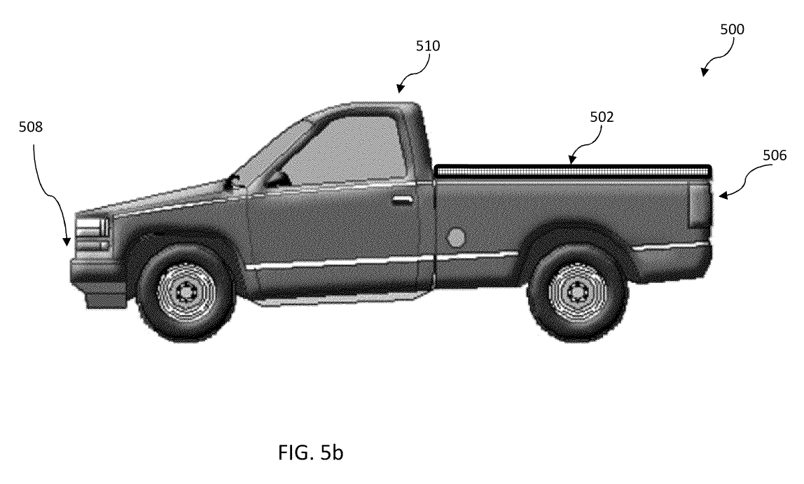

While the photovoltaic panels will be stored for the majority of the time that the vehicle is in motion, it is possible to partially deploy the panels during vehicle motion. Under the embodiment of FIG. 4, the panels can be deployed in a configuration similar to a sun roof. Under the embodiment of FIGS. 5a and 5b, the photovoltaic panels can remain fully deployed while the vehicle is in motion.

The storing and deploying of the photovoltaic panels can be accomplished automatically through a mechanical device or can be accomplished manually through a multitude of embodiments.

The photovoltaic panels do not rest on the surface of the vehicle but are supported over the surface of the vehicle. The panels can be supported over the surface of the vehicle through the use of a rail system deployed above the vehicle, a stiff backing placed on the back side of the photovoltaic panels, roller situated on top of the vehicle to support the panels, or any other system used to insure that the photovoltaic panels do not rest on the surface of the vehicle. This again insures that the essential design of the vehicle need not change to adapt to the implementation and use of the expandable photovoltaic panel system. This allows vehicle manufacturers to retain the freedom to design their vehicles without the worry of the placement of photovoltaic panels. The photovoltaic panels will be deployed around the shape of the vehicle. In one embodiment, the photovoltaic panels are slid along a track to keep them in the proper shape. In another embodiment, the photovoltaic panels are formed with flexible poles to keep the photovoltaic panel system from resting on the vehicle body.

Another advantage of the photovoltaic panel system is the protection afforded the body of the vehicle while the system is deployed. Each area covered by the photovoltaic panels is protected from the sun, rain, snow, wind, tree leaves and branches, animals and other damage while the system is deployed.

According to one exemplary embodiment, the photovoltaic paneling may also be deployed on the interior of the vehicle. While this will not afford as great of an increase in effective surface area, the installation and deployment of the photovoltaic panels is greatly simplified. In one embodiment, the photovoltaic panel system is installed on the interior of the vehicle so that when the photovoltaic panels are deployed they occupy the space directly under the windows of the vehicle. In one embodiment, the photovoltaic panels are deployed and stored by hand with retracting mechanisms attached to the upper portion of the windows.

Under another embodiment, the photovoltaic paneling is deployed from the side of a vehicle in a manner similar to a retractable awning. The storage method consists of a spring loaded rolling mechanism.

Under the embodiment of FIG. 4, the photovoltaic panels 402 are stacked on each other for storage as part of the roof of the vehicle. According to one exemplary embodiment, the photovoltaic panel system is manufactured as part of the roof of the vehicle. The photovoltaic panels 402 are deployed automatically from the roof of the vehicle and spread over the vehicle to cover a large surface area. The panels rise in a vertical direction 404 from the roof of the car while they are still stacked. When they are above the surface of the roof of the vehicle, the photovoltaic panels 402 spread outward in a direction 406 while each photovoltaic panel 402 is attached to the photovoltaic panel 402 above and below it.

To retract the photovoltaic panels 402, the photovoltaic panels 402 move toward the storage area in the roof 408 by sliding over each other. When the photovoltaic panels 402 are tightly packed over the storage area in the roof 408, they will lower into that space and once again be flush with the roof of the vehicle. The photovoltaic panels 402 shown in this embodiment may be fully deployed while the vehicle is parked and they may be partially deployed while the vehicle is in motion. The photovoltaic panels 402 that extend toward the rear of the vehicle can be deployed while the vehicle is in motion in a configuration similar to a sunroof. The design of the vehicle will remain essentially unchanged as the photovoltaic panels 402 store in the space where a sunroof would be installed. In one embodiment, the panel system is not manufactured as part of the vehicle and is simply added into the space of the sunroof. The photovoltaic panels 402 can be stacked and stored in the roof because they are thin and will not exceed the thickness of the vehicle roof panel when stacked tightly.

Under the embodiment of FIG. 5A and FIG. 5B, the expandable photovoltaic panel system is installed in a truck bed 504 and deployed by spreading the photovoltaic panel sheet 502 over the truck bed 504. The photovoltaic panel sheet 502 is attached to one side of the truck bed 504 and extends to the other side of the truck bed 504. In one embodiment, the photovoltaic panel sheet 502 extends from a lateral side of the truck bed to the other lateral side of the truck bed. In another embodiment, the photovoltaic panel sheet 502 extends from the front of the truck bed to the rear of the truck bed. Under one embodiment, the photovoltaic panel sheet 502 also acts as a truck bed covering which can be used to protect items that are placed in the bed of the truck. When deployed in this manner, the photovoltaic panel sheet 502 covers the truck bed 504.

In this configuration, the photovoltaic panel sheet 502 can be deployed while the vehicle is in motion and will function similarly to a typical truck bed cover. The photovoltaic panel sheet 502 can also be extended over the entire body of the truck by extending from the rear of the truck 606 to the front of the truck 508 and being supported over the truck cab 510. This configuration will maximize the effective surface area of the expandable photovoltaic panel system. In one embodiment, the photovoltaic panel sheet 502 can be automatically deployed from controls inside the truck. In another embodiment, the photovoltaic panel sheet 502 is deployed manually. In one embodiment, the expandable photovoltaic panel system is stored in a spring loaded canister at one end of the truck bed. The photovoltaic panel sheet will spring back into the canister when released from the opposite side of the truck bed 504.

The schematic flow chart diagram that follows is generally set forth as a logical flow chart diagram. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

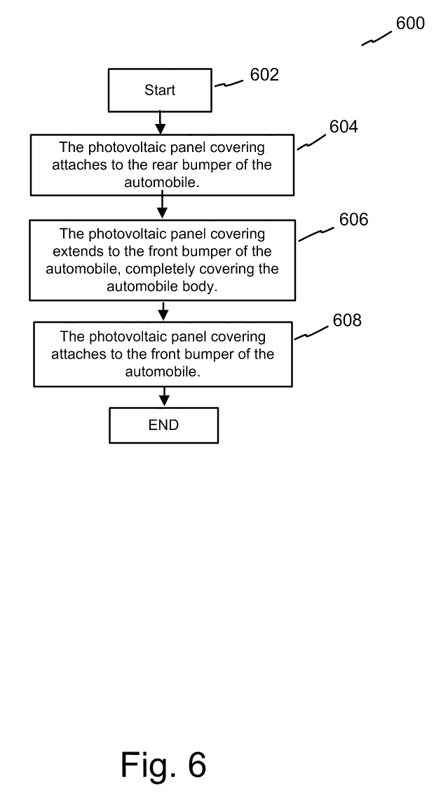

FIG. 6 is a schematic flow chart diagram illustrating one embodiment of a method 600 for improving pitching technique with the present invention. In one embodiment, the method 600 starts 602 and the photovoltaic panel covering 300 attaches 604 to the rear bumper of the vehicle. The photovoltaic panel covering extends 606 to the front bumper of the vehicle, completely covering the vehicle body. The photovoltaic panel covering attaches 608 to the front bumper of the vehicle. The method 600 then ends 610.

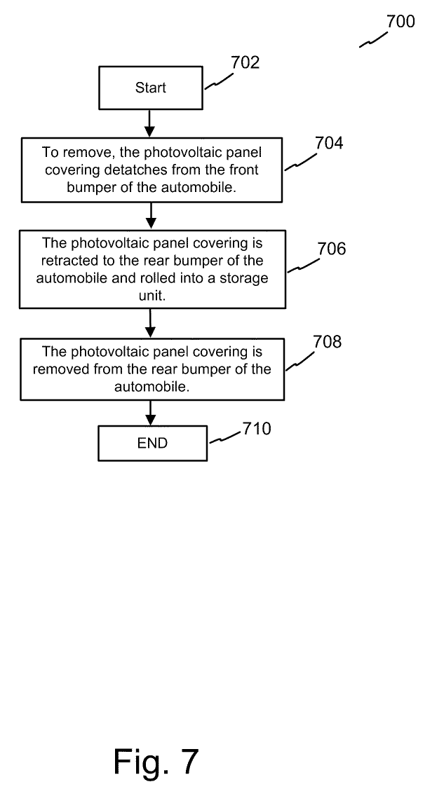

FIG. 7 is a schematic flow chart diagram illustrating, according to one exemplary embodiment, a method 700 for collapsing a photovoltaic panel cover according to the present invention. To remove the vehicle protection device 300, the method starts 702 and the panel covering detaches 704 from the front bumper of the vehicle. The photovoltaic panel covering retracts 706 to the rear bumper of the vehicle and rolls into a storage unit. The photovoltaic panel covering 300 is removed 708 from the rear bumper of the vehicle. The photovoltaic panel covering 300 can then be reattached or moved to another vehicle for use. The method 700 then ends 710.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus to collect solar energy for a motorized vehicle, the apparatus comprising:
one or more retractable photovoltaic panels configured to increase solar energy collection when deployed; and
a storage module configured to hold the photovoltaic panels when not in use, wherein the storage module is portable with the motorized vehicle.

2. The apparatus of claim 1, wherein the storage module is equipped to attach to the tow hitch of a motorized vehicle.

3. The apparatus of claim 1, wherein at least one of the retractable photovoltaic panels is configured to extended over the bed of a truck.

4. The apparatus of claim 1, wherein at least one of the retractable photovoltaic panels is configured to be deployed behind a window of the motorized vehicle.

5. The apparatus of claim 1, wherein at least one of the one or more retractable photovoltaic panels is flexible.

6. The apparatus of claim 5, wherein the at least one flexible retractable photovoltaic panel is configured to roll up for storage.

7. The apparatus of claim 5, wherein the at least on flexible retractable photovoltaic panels is flexible in one direction and stiff in another direction to allow it to bow over the motorized vehicle.

8. The apparatus of claim 1, wherein at least one of the one or more retractable photovoltaic panels are rigid.

9. The apparatus of claim 8, wherein the storage module further comprises storage means for storage of rigid retractable photovoltaic panels in an overlapping position.

10. The apparatus of claim 8 wherein storage module comprises a retraction mechanism for deployment and stacking of multiple overlapping rigid photovoltaic panels.

11. A system for collecting solar energy for a motorized vehicle, the system comprising:
one or more retractable photovoltaic panels configured to increase solar energy collection when deployed;
a storage module configured to hold the photovoltaic panels when not in use, wherein the storage module is portable with the motorized vehicle.

12. The system of claim 11, wherein the storage module is built into the body of the motorized vehicle.

13. The system of claim 11, wherein the storage module is a separate apparatus configured to be installed on a motor vehicle.

14. Thy system of claim 11, wherein the retractable photovoltaic panels are deployable to provide protection from UV light.

15. The system of claim 11, further comprising a means for storing electric energy, and wherein the collected energy is in the form of electric energy.

16. They system of claim 11, wherein the collected solar energy powers a climate control system for the motorized vehicle.

17. The system of claim 11, wherein the collected solar energy powers external devices.

18. The system of claim 11, wherein the storage module is stored in the trunk space of the vehicle.

19. The system of claim 11, wherein the storage module is at least partially located under the front and rear bumper of the vehicle.

20. The system of claim 11, wherein the storage module further comprises bottom side of vehicle storage.

21. The system of claim 11, wherein the storage module is located on the surface of a body panel of the motorized vehicle.

22. The system of claim 11, wherein the storage module is under a body panel of the motorized vehicle whereby the one or more photovoltaic panels may be stored within the body of the motorized vehicle.

23. The system of claim 22, wherein the one or more photovoltaic panels deploy in a multitude of directions.

24. The system of claim 22, wherein the body panel is a vehicle roof.

25. The system of claim 22, wherein the body panel is a vehicle hood.

26. The system of claim 22, wherein the body panel is a vehicle trunk lid.

27. A method of collecting solar energy from photovoltaic panels for a motorized vehicle, the method comprising:
providing a motorized vehicle with front and back bumpers;
providing a retractable photovoltaic panel system configured to increase solar energy collection when deployed and store the photovoltaic panels when not in use;
attaching the panel system to the rear bumper of the motorized vehicle;
extending the panel system from the rear bumper to the front of the motorized vehicle, significantly covering the body of the motorized vehicle; and
attaching the panel system to the front bumper of the motorized vehicle.
